(19) United States
(12) Patent Application Publication
(10) Pub. No.: US 2008/0074744 A1
(43) Pub. Date: Mar. 27, 2008

(54) Vibration reduction apparatus, optical equipment and a method of manufacturing the vibration reduction apparatus

(75) Inventors: Seiji Osaka, Tokyo (JP); Hidenori Miyamoto, Urayasu-shi (JP)

Correspondence Address: OLIFF & BERRIDGE, PLC, P.O. BOX 320850, ALEXANDRIA, VA, 22320-4850, US

(73) Assignee: NIKON CORPORATION, TOKYO (JP)

(21) Appl. No.: 11/902,436

(22) Filed: Sep. 21, 2007

(30) Foreign Application Priority Data
Sep. 27, 2006 (JP) 2006-262411
Sep. 27, 2006 (JP) 2006-262433

(51) Int. Cl. G02B 27/64

(52) U.S. Cl. 359/554

(57) ABSTRACT

To provide a vibration reduction apparatus with improved blur correcting precision, an optical equipment and a method of manufacturing a vibration reduction apparatus with improved blur correcting precision. A vibration reduction apparatus comprising: a first member and a second member disposed to be opposite to each other and to be movable relative to each other when blur is correcting; and a wiring member that exerts a force between the first member and the second member along a direction that intersects with a direction of the relative movement of the first member and the second member.

The disclosure of the following priority application is herein incorporated by reference: Japanese Patent Applications No. 2006-262411 and No. 2006-262433 filed on Sep. 27, 2006.

### BACKGROUND OF THE INVENTION

1. Field of the Invention

The present invention relates to a vibration reduction apparatus, optical equipment, and a method of manufacturing the vibration reduction apparatus.

2. Description of Related Art

The vibration reduction apparatus provided in optical equipment such as a camera is known. The conventional vibration reduction apparatus has a lens frame hold a blur correcting lens therein and movable relative to a fixing member. The lens frame moves relative to the fixing member during blur correcting. The conventional vibration reduction apparatus comprises a flexible wiring substrate, that supplies power to an actuator and a position detecting sensor or the like, which is mounted on the lens frame. Thus the wiring substrate might become resistance for relative movement between the lens frame and the fixing member, and might decrease the accuracy of the blur correction.

As a conventional vibration reduction apparatus, there is known an apparatus in which a sensor to detect the movement of a blur correcting lens or the like is mounted near the bending portion of the wiring board (for example, refer to Japanese Unexamined Patent Application Publication No. Hei 06-289465).

### SUMMARY OF THE INVENTION

An object of the present invention is to provide a vibration reduction apparatus with improved blur correcting precision, an optical equipment and a method of manufacturing a vibration reduction apparatus with improved blur correcting precision.

The present invention solves the above problems by the following solution approach.

According to the first aspect of the present invention, a vibration reduction apparatus comprising: a first member and a second member disposed to be opposite to each other and to be movable relative to each other when blur is correcting; and a wiring member that exerts a force between the first member and the second member along a direction that intersects with a direction of the relative movement of the first member and the second member.

The wiring member may exert the force along a direction orthogonal to a plane on which the first member and the second member move relatively.

The wiring member may be provided to be bent between the first member and the second member.

The wiring member may have a first plane provided along the first member and a second plane provided along the second member.

The first plane and the second plane of the wiring member may be parallel with each other.

The wiring member may have a fixing portion secured to at least one of the first member and the second member, on at least one of the first plane and the second plane.

The first plane may have: a first fixing portion secured to the first member; and a first movable portion provided from the first fixing portion along the first member to be movable relative to the first member.

The second plane may have: a second fixing portion secured to the second member; and a second movable portion provided from the second fixing portion along the second member to be movable relative to the second member.

The wiring member may have: at least one bending portion provided by bending a portion which extend from a portion along at least one of the first member and the second member.

Even number of the bending portions may be provided.

A plurality of bending portions may be provided on the wiring member, and the wiring member may further comprise an opposite portion opposed to at least one of the first member and the second member between a bending portion and another bending portion.

The wiring member may have: a first wiring portion provided along a plane on which the first member and the second member moves relatively; and a second wiring portion provided along a plane on which the first member and the second member moves relatively and apart from the first wiring portion.

The second wiring portion may be provided along a direction intersected with the direction that the first wiring portion is provided.

The second wiring portion may be provided along a direction orthogonal to the direction that the first wiring portion is provided.

The wiring member may comprise a connecting portion that connects the first wiring portion and the second wiring portion, the connecting portion being provided along at least one of the first member and the second member.

At least one of the first wiring portion and the second wiring portion may comprise: a first plane opposed to the first member; a second plane opposed to the second member; and at least one bending portion provided by bending a plane continuous with the first plane and the second plane.

At least one part of the wiring member may be a stripe shape.

The wiring member may be a flexible printed circuit.

The vibration reduction apparatus may further comprise a blur correcting lens provided on at least one of the first member and the second member.

The vibration reduction apparatus may further comprise an imaging element provided on at least one of the first member and the second member.

According to the second aspect of the present invention, a vibration reduction apparatus comprising: a first member and a second member provided to be opposite to each other and to be movable relative to each other when blur is correcting; and a wiring member provided between the first member and the second member to connect the first member and the second member electrically, wherein the wiring member exerts an elastic force between the first member and the second member along a direction that intersects with the direction of the relative movement of the first member and the second member.

The wiring member may comprise: a first plane opposed to the first member; a second plane opposed to the second member; and at least one bending portion provided by bending a plane continuous with the first plane and the second plan.

According to the third aspect of the present invention, a vibration reduction apparatus comprising: a first member and a second member provided to be opposite each other and to be movable relative to each other when blur is correcting; and a wiring member provided between the first member and the second member, wherein the wiring member includes: a first plane opposed to the first member; a second plane opposed to the second member, and at least one bending portion provided by bending a plane continuous with the first plane and the second plane.

The wiring member may exert a force between the first member and the second member along a direction that intersects with the direction of the relative movement of the first member and the second member.

At least one of the first plane and the second plane may have a fixing portion secured to at least one of the first member and the second member.

The first plane may have: a first fixing portion secured to the first member; and a first movable portion provided from the first fixing portion along the first member to be movable relative to the first member.

The second plane may have: a second fixing portion secured to the second member; and a second movable portion provided from the second fixing portion along the second member to be movable relative to the second member.

According to the fourth aspect of the present invention, a vibration reduction apparatus comprising: a sensor to detect relative movement of a first member and a second member movable relative to each other in a plane perpendicular to an optical axis when blur is correcting; a loading portion to load the sensor and disposed on a plane perpendicular to the optical axis of the first member; and a flexible member having a bending portion bent from the loading portion, wherein the loading portion is provided with a notch portion at an outer side of the sensor.

The loading portion may be provided with notch portions on three portions at the outer side of the sensor.

The flexible member may be a flexible printed circuit.

The notch portion may have a first notch provided between the sensor and the bending portion of the flexible member.

The notch portion may have a second notch and a third notch respectively formed at each ends of the first notch continuously so as to dispose the sensor therebetween.

The first member or the second member may support a blur correcting lens or an imaging element.

According to the fifth aspect of the present invention, an optical equipment comprising a vibration reduction apparatus according to claim 1.

According to the sixth aspect of the present invention, a method for manufacturing a vibration reduction apparatus, comprising steps of: providing a first member and a second member opposite to each other and movable relative to each other when blur correcting; and disposing wiring members to exert a force along a direction that intersects with a direction of relative movement of the first member and the second member between the first member and the second member.

According to the seventh aspect of the present invention, a method of manufacturing a vibration reduction apparatus, comprising steps of: providing a first member and a second member to be opposite to each other and to be movable relative to each other when blur correcting; connecting electrically the first member and the second member via a wiring member, and disposing the wiring member to exert an elastic force along a direction that intersects a direction of the relative movement of the first member and the second member between the first member and the second member.

According to the eighth aspect of the present invention, a method of manufacturing a vibration reduction apparatus, comprising steps of: providing a first member and a second member to be opposite to each other and to be movable relative to each other when blur correcting; and disposing a wiring member between the first member and the second member so that a first plane is opposed to the first member and a second plane other than the first plane is opposed to the second member.

These configurations may change arbitrarily and may substitute at least a part for other components.

According to the above configuration, a vibration reduction apparatus with high blur correction precision, optical equipment, and a method of manufacturing the vibration reduction apparatus with high blur precision, can be provided.

### BRIEF DESCRIPTION OF THE DRAWINGS

FIG. 1 is a perspective view showing the camera system of an embodiment;

FIG. 2A is a plan view showing the vibration reduction apparatus provided in the camera system of FIG. 1, viewed from one side of the optical axis direction;

FIG. 2B is an enlarged view of portion b of FIG. 2A.

FIG. 3A is a bottom view with cashing lid detached showing the vibration reduction apparatus of FIG. 2, viewed from the other side of the optical axis direction;

FIG. 3B is a bottom view with cashing lid mounted showing the vibration reduction apparatus of FIG. 2, viewed from the other side of the optical axis direction;

FIG. 4A is a cross-sectional view showing a vibration reduction apparatus, taken in the direction of the arrows along the line IVa-IVa of FIG. 2A;

FIG. 4B is a cross-sectional view showing a vibration reduction apparatus, taken in the direction of the arrows along the line IVb-IVb of FIG. 2A;

FIG. 5 is a cross-sectional view showing a vibration reduction apparatus, taken in the direction of the arrows along the line V-V of FIG. 2;

FIG. 6 is a cross-sectional view showing a vibration reduction apparatus, taken in the direction of the arrows along the line VI-VI of FIG. 2;

FIG. 7 is a cross-sectional view showing the vibration reduction apparatus in comparison embodiment;

FIG. 8 is a view, corresponding to FIG. 5, illustrating a modification of the present embodiment; and

FIG. 9 is a view, corresponding to FIG. 5, illustrating a further modification of the present embodiment.

### DETAILED DESCRIPTION OF THE INVENTION

Hereafter, an embodiment of the present invention is described in more detail with reference to the drawings. The following embodiment is described by taking a camera system as optical equipment comprising a vibration reduction apparatus, as an example.

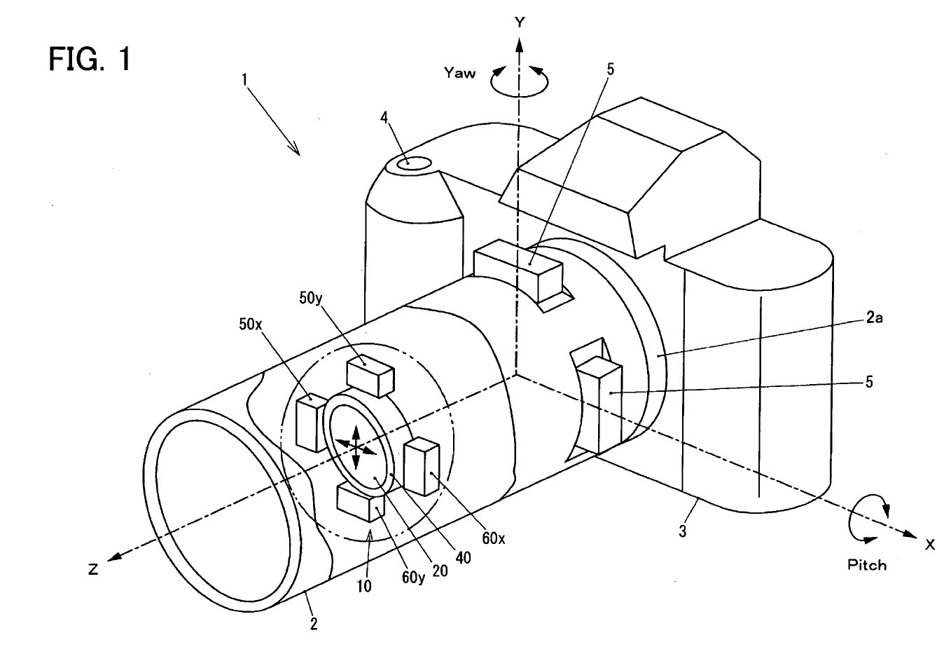

FIG. 1 is a perspective view showing the camera system of the embodiment of the present invention. In FIG. 1, a camera system 1 of the embodiment has an interchangeable lens 2 and a camera body 3.

The interchangeable lens 2 has a cylindrical shape as a whole, and the end at the image side in an optical axis direction is secured to the camera body 3 detachably through a mounting portion 2a. The interchangeable lens 2 is provided with a vibration reduction apparatus 10 and a plurality of lens unit arranged on an optical axis Z (lens unit other than a blur correcting lens 20 are not shown in the figure).

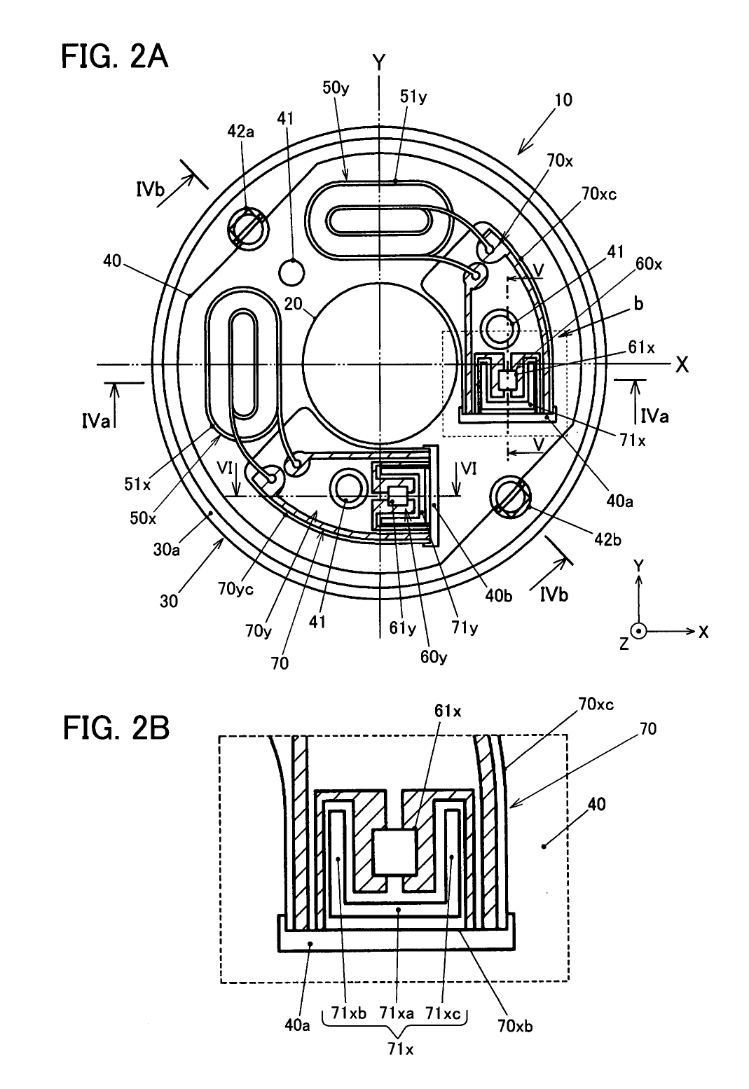

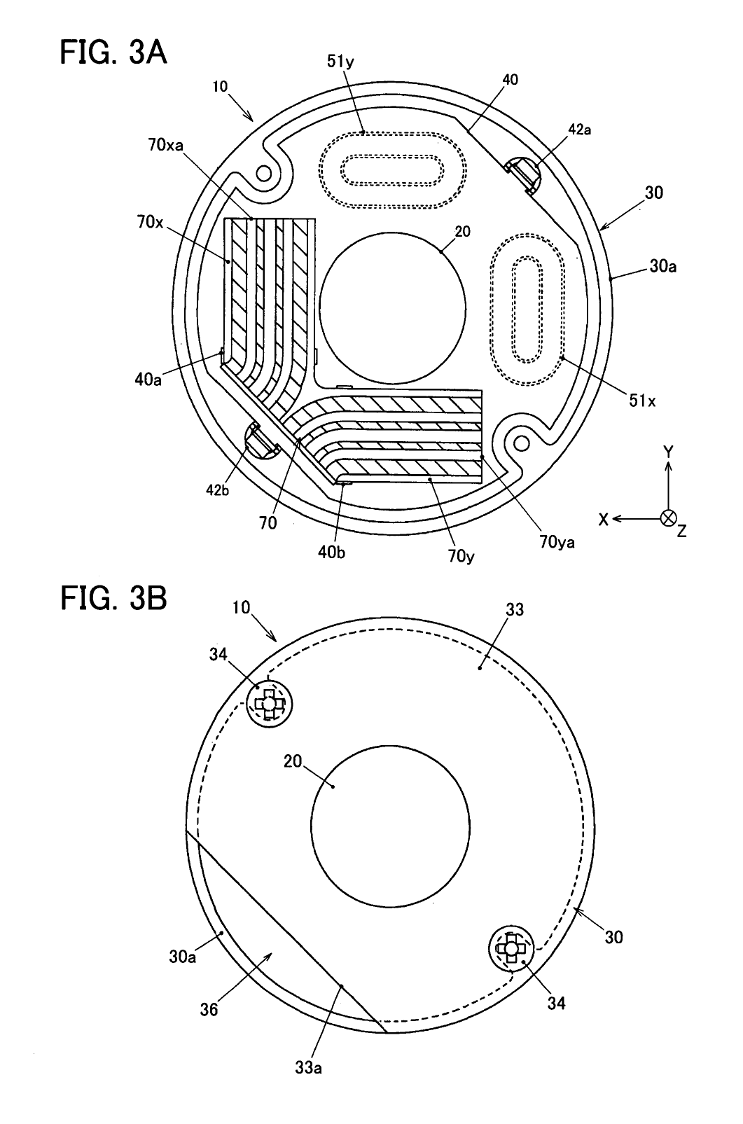

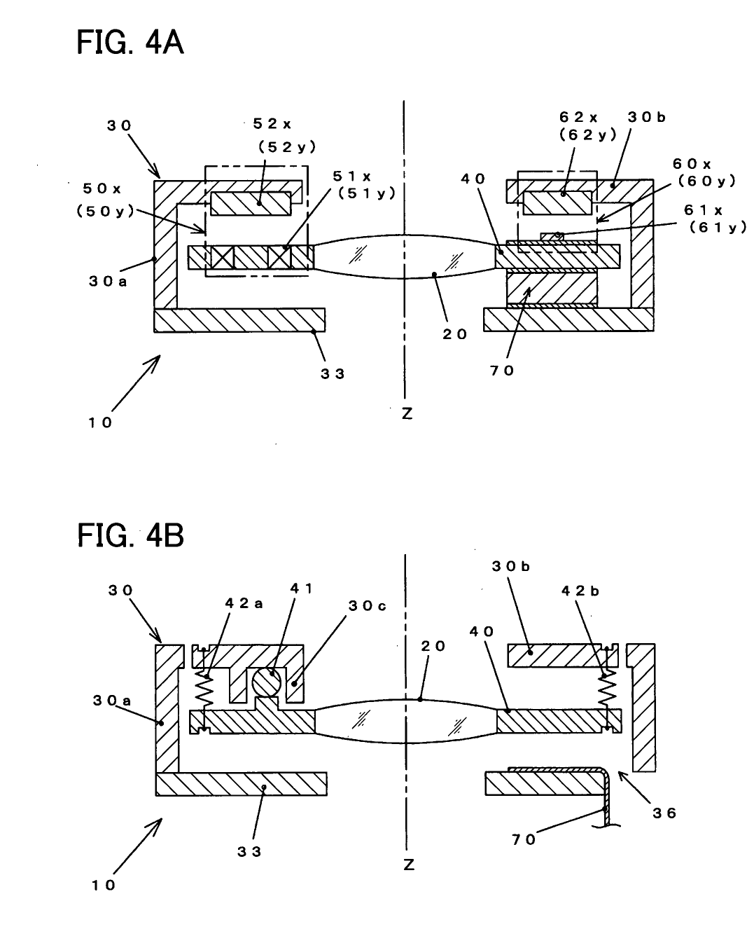

FIGS. 2A, 2B are plan views showing the vibration reduction apparatus provided in the camera system of FIG. 1, viewed from one side of the optical axis direction. FIG. 2A shows a general view of the vibration reduction apparatus. FIG. 2B is an enlarged view of portion b of FIG. 2A. FIGS. 3A, 3B are a bottom view showing the vibration reduction apparatus of FIGS. 2A and 2B, viewed from the other side of the optical axis direction. FIG. 3A shows a state where the casing lid of the vibration reduction apparatus is detached. FIG. 3B shows a state where the casing lid of the vibration reduction apparatus is mounted. FIGS. 4A, 4B are a cross-sectional view showing a vibration reduction apparatus, taken in the direction of the arrows along the line IV-IV of FIGS. 2A, 2B. FIG. 4A shows a cross-sectional view taken in the direction of the arrows along the line IVa-IVa of FIG. 2A. FIG. 4B shows a cross-sectional view taken in the direction of the arrows along the line IVb-IVb of FIG. 2A.

In FIG. 2A, the vibration reduction apparatus 10 is provided with a blur correcting lens 20, a vibration reduction apparatus case 30, a movable lens frame 40, voice coil motors (VCM) 50x and 50y(refer to FIG. 4A), position detecting portions 60x and 60y (refer to FIG. 4A), and a flexible printed circuit board (FPC) 70.

The vibration reduction apparatus 10 corrects image blur in the photographing portion by moving the blur correcting lens 20, which is part of the photographing optical system, in a direction that counteracts image blur caused by a photographer's hand shakiness, etc., to the photographing portion (imaging element or film, not shown) in a plane perpendicular to the optical axis Z, placed in the focal plane of the photographing optical system.

As shown in FIG. 4A, a vibration reduction apparatus case 30 is a portion in which a movable lens frame 40 described later is accommodated, and is provided with a sidewall 30a, a top plane 30b, and a casing lid 33 of the vibration reduction apparatus.

As shown in FIG. 4A, the sidewall 30a is a part formed in a cylindrical shape, with the central axis thereof is arranged in a state substantially concordant with the optical axis Z.

The top plane 30b is a part formed in a flange shape by projecting from an end of one side of the optical axis direction of the sidewall 30a to the inside diameter side of the sidewall 30a. In order to facilitate the understanding of the constitution of the movable lens frame 40 described later, the top plane 30b is omitted in FIGS. 2A, 2B.

Referring to FIGS. 3B and 4A, the casing lid 33 of the vibration reduction apparatus has a near circular board member viewed from the optical axis direction, and is provided with a substantially circular opening at the central portion thereof. The casing lid 33 of the vibration reduction apparatus is mounted to the other side in the optical axis direction of the sidewall 30a, and is fixed to the sidewall 30a by way of fitting screws 34.

Moreover, the casing lid 33 of the vibration reduction apparatus has a notch portion 33a formed by notching a part of the peripheral portion thereof to be straight. As a result, the vibration reduction apparatus case 30 is provided with an opening 36 at the other end side thereof in the optical axis direction.

In FIG. 4B, the movable lens frame 40 is constituted of a disk shaped member having an opening at a central portion thereof, and is inserted at the inner diameter side of the sidewall 30a of the vibration reduction apparatus case 30. The abovementioned blur correcting lens 20 is mounted to a central portion of the movable lens frame 40.

The movable lens frame 40 is supported to be movable in a plane perpendicular to the optical axis Z relative to the vibration reduction apparatus case 30, by a steel ball 41 placed between the movable lens frame 40 and the top plane 30b.

For example, three steel balls 41 are arranged around the optical axis at substantially equal intervals (refer to FIG. 2A). Moreover, the steel balls 41 are accommodated in a steel ball hold portion 30c formed to the top plane 30b in the cup shape. In addition, the embodiment shown in the figure is described to use the steel ball 41, but a ball constituted of metallic material other than steel, alloy and ceramic material may be used.

The movable lens frame 40 is biased in the direction that approaches the top plane 30b of the vibration reduction apparatus case 30 by springs 42a and 42b. The springs 42a and 42b are extension coil springs having one end connected to the top plane 30b of the vibration reduction apparatus case 30 and the other end connected to the movable lens frame 40.

As shown in FIG. 2A, a couple of springs 42a and 42b are provided across the blur correcting lens 20, one spring 42a being arranged between a couple of coils 51x and 51y described later, and the other spring 42b being arranged between a couple of Hall elements 61x and 61y described later.

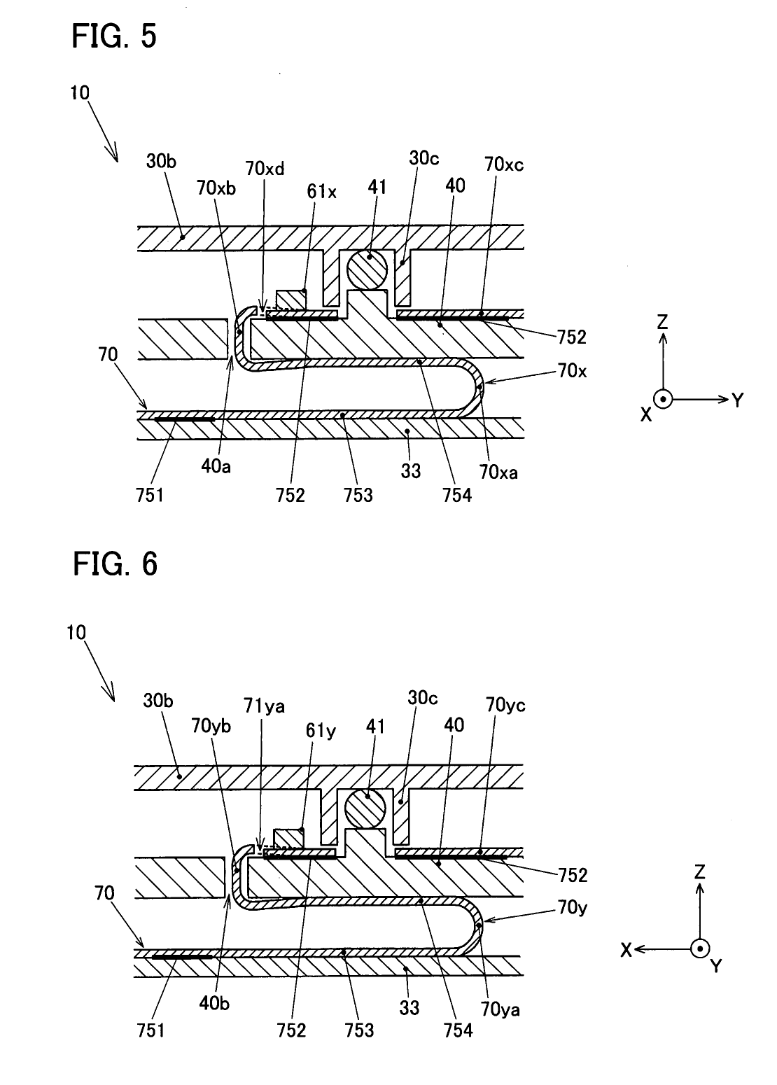

FIG. 5 is a cross-sectional view showing a vibration reduction apparatus, taken in the direction of the arrows along the line V-V of FIG. 2A. The movable lens frame 40 includes a first slit 40a and a second slit 40b.

The first slit 40a and the second slit 40b are formed to extend through the movable lens frame 40 in the thickness direction, and are rectangular holes that extend in the directions perpendicularly intersecting each other (X axis direction and Y axis direction described later, respectively).

A first slit 40a is formed near a Hall element 61x and a second slit 40b is formed near a Hall element 61y, respectively.

VCMs 50x and 50y are electromagnetic actuators which drive the blue correcting lens 20 in the directions orthogonal to two axles (hereafter referred to as X axis and Y axis) in a plane orthogonal to the optical axis Z. The VCM 50x is a motor for driving the blue correcting lens 20 along the direction of the X axis and the VCM 50y is a motor for driving the blue correcting lens 20 along the direction of the Y axis.

Hereafter, VCMs 50x and 50y, position detecting portions 60x and 60y described later, and respective elements included therein, are described by appending the sign x to the element for the direction of the X axis, and the sign y to the element for the direction of the Y axis, respectively.

The VCM 50x is arranged in such a manner that the electromagnetic force effects to the center of the blur correcting lens along the axis parallel to the X axis. The VCM 50y is arranged in such a manner that the electromagnetic force effects to the center of the blur correcting lens along the axis parallel to Y axis. In the VCMs 50x and 50y, and the position detecting portion 60x and 60y, the constitution of the elements for the X axis direction and the constitution of elements for the Y axis direction are substantially identical. Therefore, as the constitution of the VCM 50y and the position detecting portion 60y, in FIG. 4A showing the VCM 50x and the position detecting portion 60x, the elements 50y and 60y are shown by fixing the sign with parentheses.

The VCM 50x has a coil 51x and a magnet 52x as shown in FIG. 4A.

The coil 51x is an armature winding fixed to the movable lens frame 40.

The magnet 52x is a permanent magnet fixed to the top plane 30b of the vibration reduction apparatus case 30 in the opposed state to the coil 51x.

The VCM 50y (refer to FIG. 2A) also has a coil 51y (refer to FIG. 2A) and a magnet 52y (refer to FIG. 4A) as well as the VCM 50x.

In FIG. 2A, the position detecting portions 60x and 60y detect the movement relative to the vibration reduction apparatus case 30 of the movable lens frame 40, the position detecting portion 60x detects the movement in the X axis direction, and the position detecting portion 60y detects the movement in the Y axis direction.

The position detecting portion 60x is arranged at the side opposite to the VCM 50x of the blur correcting lens 20, and the position detecting portion 60y is arranged at the side opposite to VCM 50y of the blur correcting lens 20.

In FIG. 4A, the position detecting portion 60x comprises the Hall element 61x and the magnet 62x.

The Hall element 61x is a magnetic sensor fixed to the movable lens frame 40 via an FPC 70 described later.

The magnet 62x is a permanent magnet fixed to the top plane 30b of the vibration reduction apparatus case 30 in a state opposed to the coil 61x.

The position detecting portion 60y (refer to FIG. 2A) also comprises the Hall element 61y and the magnet 62y (refer to FIG. 4A) as well as the position detecting portion 60x.

In the position detecting portions 60x and 60y, the Hall elements 61x and 61y detect and output the change in the magnetic field of the magnets 62x and 62y corresponds to the movement in the vibration reduction apparatus case 30 of the movable lens frame 40, and a CPU (not shown) provided in the interchangeable lens 2 calculates the distance moved of the movable lens frame 40 on the basis of the output.

In FIG. 2A and FIG. 3A, the FPC 70 is a sheet-shaped flexible wiring board to electrically connect, for example, the CPU of the interchangeable lens 2, and, coils 51x, 51y, and Hall elements 61x, 61y. The CPU may be provided in the camera main body 3. In this instance, the FPC 70 may be connected electrically to the CPU of the camera main body 3 through an electric contact (not shown) connecting interchangeable lens 2 and the camera main body 3. The FPC 70 is, for example, formed by providing conductive patterns on a sheet member made of plastic material.

In FIG. 2A and FIG. 3A, the FPC 70 has an X side FPC 70x and a Y side FPC 70y. The FPC 70 is split to be forked to form the X side FPC 70x and the Y side FPC 70y.

As shown in FIGS. 3A and 3B, the FPC 70 is inserted from the forementioned opening 36 formed in the vibration reduction apparatus case 30 into the interior thereof. Moreover, the FPC 70 has an end placed outside of the vibration reduction apparatus case 30, which is connected to a CPU (not shown) provided to the interchangeable lens 2.

As shown in FIG. 3A, the FPC 70 is disposed in such a manner that the region inserted through the opening 36 of the vibration reduction apparatus case 30, extends in the direction at an angle of, for example, 45 degrees to the X axis and the Y axis. As shown in FIG. 5, in the FPC 70, a fixing portion 751 opposed to the casing lid 33 is adhered to the casing lid 33.

In FIG. 2A, the X side FPC 70x is curved along the peripheral direction of the movable lens frame 40, and electrically connects the coil 51y, the Hall element 61x, and the CPU provided to the interchangeable lens 2. The Y side FPC 70y electrically connects the coil 51x, the Hall element 61y, and the CPU.

As shown in FIG. 5, the X side FPC 70x is secured to the casing lid 33 at the fixing portion 751, is extended along the casing lid 33 without being secured to the casing lid 33 at the non-fixing portion 753, is folded back nearly 180 degrees at the first folding back portion 70xa, is extended along the movable lens frame 40 without being secured to the movable lens frame 40 at the non-fixing portion 754, is inserted through a first slit 40a and then is folded back nearly 180 degrees at the second folding back portion 70xb, and is extended along the movable lens frame 40 by being opposed to the top plane 30b of the movable lens frame 40. A part extended along the movable lens frame 40 opposed to the top plane 30b is a mount portion 70xc, which is secured to the movable lens frame 40 at a fixing portion 752.

A first folding back portion 70xa is a folded portion formed by bending the X side FPC 70x, and the FPC 70x has a substantially U-shaped form viewed from the X direction. Non-fixing portions 753 and 754 provided on both sides of the substantially U-shaped portion of the FPC 70x are not secured to the casing lid 33 and the movable lens frame 40, respectively, so that the X side FPC 70x deforms so as to follow for the movement of the movable lens frame 40, in the case where the movable lens 40 moves in the Y direction shown in the figure. Therefore, even if the movable lens frame 40 moves in the Y direction shown in the figure, the frame 40 does not receive any substantial resistive force from the X side FPC 70x.

Furthermore, a first folding back portion 70xa formed by bending the X side FPC 70x is provided between the casing lid 33 and the movable lens frame 40 so that the movable lens frame 40 only receives the elastic force in a direction away from the casing lid 33 (+Z direction), from the X side FPC 70x, so that the frame 40 does not receive the resistive force in the moving direction of the movable lens frame 40 (X and Y directions).

In FIG. 5, the second folding back portion 70xb of the X side FPC 70x is formed by bending the X side FPC 70x, so that an elastic force in the direction which the mount portion 70xc is peeled off from the movable lens frame 40 (+Z direction), is generated between the movable lens frame 40 and the mount portion 70xc. As the mount portion 70xc is provided with a Hall element 61x, if the mount portion 70xc peels off from the movable lens frame 40 and gets closer to the top plane 30b, accurate signals would not be obtained from the Hall element 61x.

Therefore, the X side FPC 70x is provided with the notch portion 71x for preventing the mount portion 70xc from being peeled off from the movable lens frame 40 by the elastic force generated from the second folding back portion 70xb.

The notch portion 71x is described in detail referring to FIG. 2B. In FIG. 2B, for example, tow strip-shaped conductive patterns disposed to both ends of the lateral direction of the X side FPC 70x among four strip-shaped conductive patterns formed to the X side FPC 70x, are connected to conductive lines provided to the coil 51y. Two remaining strip-shaped conductive patterns are mounted to the Hall element 61x.

The notch portion 71x encloses a Hall element 61x on a mount portion 70xc of the X side FPC 70x, and is formed by cutting away a part except for the conductive pattern.

More specifically, the notch 71x is provided with a first notch 71xa, a second notch 71xb, and a third notch 71xc. The first notch 71xa is arranged between the Hall element 61x and the second folding back portion 70xb (refer to FIG. 5), and is formed along the lateral direction of the X side FPC 70x (X axis direction).

The second notch 71xb and the third notch 71xc are respectively formed continuously at both ends of the first notch 71xa. The second notch 71xb and the third-notch 71xc are provided so as to sandwich the Hall element 61x therebetween, and extend in the longitudinal direction of the FPC 70x on the X side (Y axis direction). As a result, the notch 71x is formed in a substantially U-shaped configuration as a whole.

FIG. 6 is a cross-sectional view showing the vibration reduction apparatus, viewed along the line indicated by the arrows VI-VI in FIG. 2. As shown in FIG. 6, the Y side FPC 70y is also provided with a first folding back portion 70ya, a second folding back portion 70yb, a mount portion 70yc, and a notch portion 71y, as well as the X side FPC 70x. As shown in FIG. 2, the notch portion 71y is formed in a substantially U-shaped configuration as a whole as well as the notch portion 71x. The Y side FPC 70y has the same constitution as to the X side FPC 70x, and therefore a detailed explanation thereof is omitted.

In the above explained camera system 1, when the release switch 4 provided to the camera main body 3 is operated, the blur detecting sensor 5 provided to the interchangeable lens 2 detects and outputs the angular velocities around the X axis and Y axis. The blur around the X axis is called pitching (Pitch) and the blur around Y axis is called yawing (Yaw) respectively, and the blur correcting action is performed, for example, by correcting image blurs cased by the blurring in the two directions.

The vibration reduction apparatus 10 performs the correction control for a well-known image blur in such a manner that the CPU (not shown) calculates a driving direction and driving amount of a blur correcting lens 20 on the basis of the output of a blur detecting sensor 5, and the VCMs 50x and 50y are controlled according to the calculated result, thereby driving the blur correcting lens 20.

According to the vibration reduction apparatus 10 of the present embodiment, the following effects can be obtained.

(1) In the vibration reduction apparatus of the present embodiment, as shown in FIGS. 5 and 6, the first folding back portions 70xa and 70ya of the FPC 70x and 70y, respectively, are provided between the casing lid 33 and the movable lens frame 40 so that the restorative force to restore the original configuration thereof by the first folding back portions 70xa and 70ya, acts on the direction that the casing lid 33 and the movable lens frame 40 are segregated.

Thus, the restoring force of the FPC 70 acts in a direction orthogonal to the direction of the relative movement to the vibration reduction apparatus case 30 of the movable lens frame 40, therefore the VCM 50 does not become a resistor in a case of driving the movable lens frame 40 in the plane perpendicular to the optical axis of the casing lid 33 of the vibration reduction apparatus. As a result, the blur correction precision of the vibration reduction apparatus 10 can be improved.

(2) For example, in a case of driving the movable lens frame 40 in the direction of X the axis by the VCM 50x, a force acts on the Y side FPC 70y in a direction orthogonal to the longitudinal direction of the FPC 70y. The Y side FPC 70y is made to twist by the force, however, for example, the restorative force against the twist of the FPC is small to the extent that can be substantially disregarded, compared with the restorative force in a case of restoring the bent FPC to its original shape. Therefore, the restorative force does not become a resistor in a case of driving the movable lens frame 40 in the vibration reduction apparatus case 30.

(3) The direction of the restoring force of the X side FPC 70x and the Y side FPC 70y is the same as the direction of the biasing of the movable lens frame 40 by the spring 42 (42a, 42b) so that the biasing of the movable lens frame 40 by the spring 42 is not hindered by this restoring force. Thus, in the vibration reduction apparatus 10, the restoring force of the X side FPC 70x and the Y side FPC 70y act in the direction that the movable lens frame 40 approaches the top plane 30b, so that the spring 42 can be constituted by using a spring with little elastic force. In some instances, the spring 42 can be omitted.

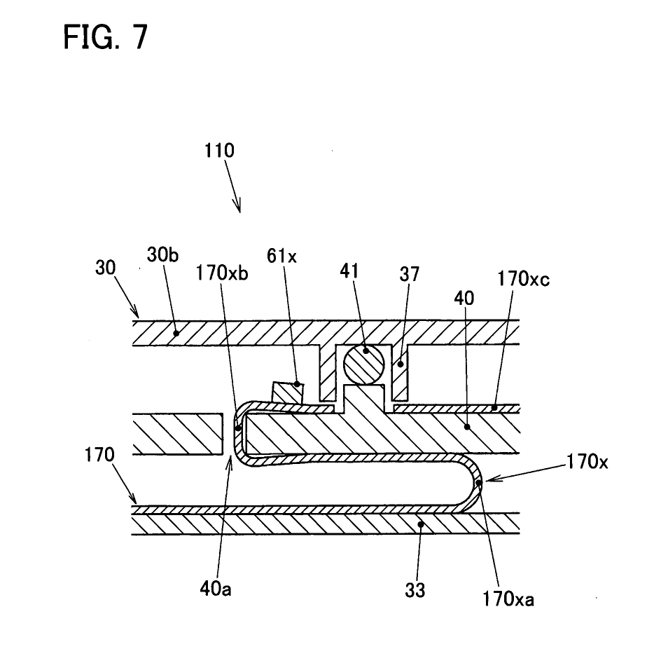

(4) FIG. 7 is a cross-sectional view of the vibration reduction apparatus of the comparison embodiment, and is a cross-sectional view of the part that corresponds to FIG. 5 showing the vibration reduction apparatus of the embodiment.

A vibration reduction apparatus 110 of the comparison embodiment is different from the vibration reduction apparatus 10 of the embodiment of the present invention in the point that the mount portion 170xc is not provided with the notch portion 71x (refer to FIG. 5).

In the vibration reduction apparatus 10 of the embodiment shown in FIG. 5 and the vibration reduction apparatus 110 of the comparison mode shown in FIG. 7, the FPCs 70x and 170x are folded back by, for example, 180 degrees in the second folding back portions 70xb and 170xb, so that the FPCs 70x and 170x try to restore to the original shape in this part.

Here, the restoring force that the FPCs 70x and 170x trying to restore to an original shape acts in the direction that the mount portions 70xc and 170xc of the FPC 70x and FPC 170x, respectively, are detached from the plane of the movable lens frame 40. This force acting to detach the mount portions 70xc and 170xc from the movable lens frame 40, becomes large as the second folding back portions 70xb and 170xb get closer.

In vibration reduction apparatus 110 of the comparison embodiment shown in FIG. 7, in the case, for example, when the force to detach the FPC 170x from the movable lens frame 40 becomes larger than the adhesive power of a binding agent for adhering the FPC 170x to the movable lens frame 40, the FPC 170x is detached from the movable lens frame 40.

In a case of the FPC 170x is detached from the movable lens frame 40, the position of the Hall element 61x relative to the movable lens frame 40 changes, and there is a possibility that the calculation of the moving distance of the movable lens frame 40 relative to the vibration reduction apparatus case 30 can not be performed accurately.

On the contrary, in the vibration reduction apparatus 10 of the embodiment shown in FIG. 5, the first notch 71xa is formed between the Hall element 61x and the second folding back portion 70xb so that a force to affect the direction that the FPC 70x is detached from the movable lens frame 40 is cutoff by this part. Therefore, the region near the second folding back portion 70xb among regions near the Hall element 61x in the FPC 70x, is prevented from being detached from the movable lens frame 40.

Furthermore, as shown in FIG. 2B, a second notch 71xb and a third notch 71xc are formed so as to sandwich the Hall element 61x therebetween so that a force to detach away the FPC 70x from the movable lens frame 40 is similarly cutoff by these notches. As a result, a region (Hall element side) inside of the second notch 71b and the third notch 71c among the region near the Hall element 61x in the FPC 70x prevents from being detached from the movable lens frame 40.

Moreover, in FIG. 5, the region opposed to the first notch 71xa of the Hall element 61x among the FPC 70x is spaced from the second folding back portion 70xb so that a force to be detach the FPC 70x from the movable lens frame 40 is small to the extent that can be substantially ignored.

As a result, the position relative to the movable lens frame 40 of the Hall element 61x becomes stable, and the moving distance of the movable lens frame 40 relative to the vibration reduction apparatus case 30 can surely be calculated. The above effect can be said for the Hall element 61y shown in FIG. 6.

### [Modification]

The present invention is not limited to the above explained embodiment, various changes and modifications are made possible, and these are also being within the technical scopes of the present invention.

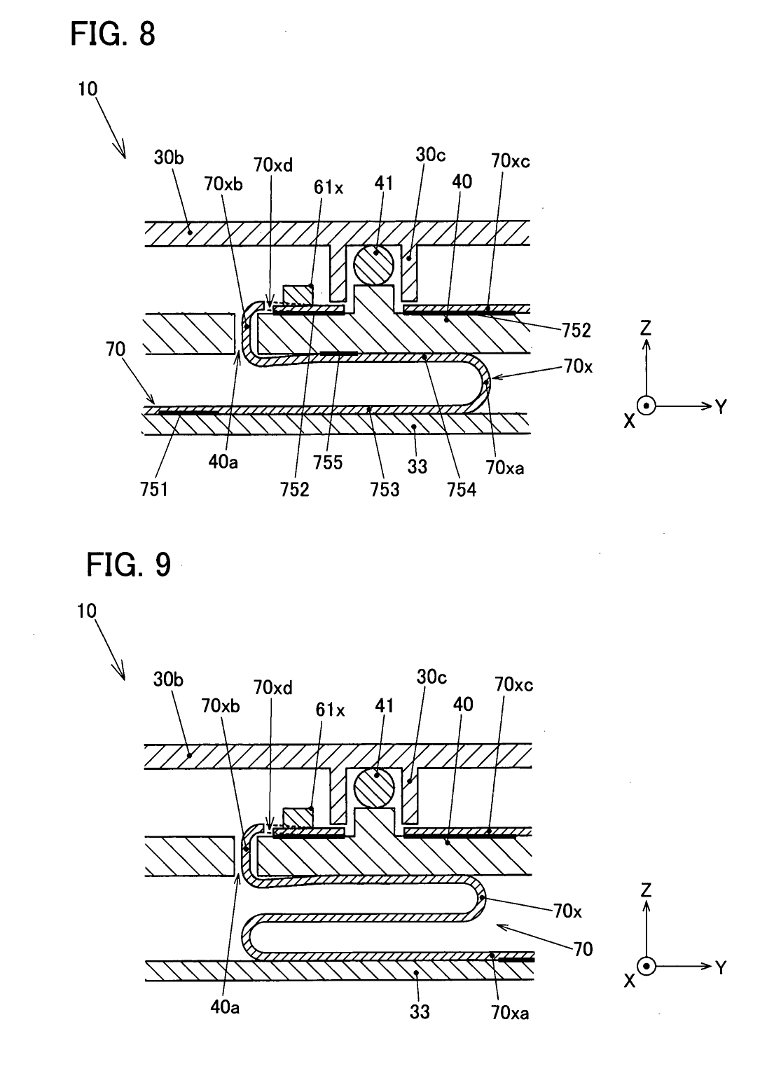

(1) In the vibration reduction apparatus of the present embodiment, the FPC 70x is fixed to the movable lens frame 40 at two places of the fixing portion 751 and the fixing portion 752, as shown in FIG. 5. However, the present invention is not limited thereto. FIG. 8 shows the modified embodiment of the above embodiment, and the figure corresponds to FIG. 5. As shown in the figure, the FPC 70x may be secured at the fixing portion 755 in the side of the casing lid 33 in the movable lens frame 40 additionally. In the FPC 70x, the fixing portion 755 is provided between the folding back portion 70xb and the non-fixing portion 754 extending from the first folding back portion 70xa. According to the modification, even though the FPC 70x is secured to the movable lens frame 40 at the fixing portion 755, the non-fixing portion 754 still exists. Therefore, the FPC 70x can be deformed so as to follow to the movement of the movable lens frame 40 when the movable lens frame 40 moves in the Y direction as shown in the figure. Therefore, even if the movable lens frame 40 moves in the Y direction as shown in the figure, the effect of receiving no substantial resistive force from the X side FPC 70x can be obtained as well as the present embodiment. Additionally, the FPC 70 is secured to the movable lens frame 40 facing to the side of the casing lid 33, so that there is a further effect that the FPC 70 can be retained with more stability.

(2) As shown in FIG. 5, the FPC 70x of the vibration reduction apparatus in the above embodiment is folded back in two places at the first folding back portion 70xa and the second folding back portion 70xb. However, the numbers of folding back is not limited to two. FIG. 9 is a view, corresponds to FIG. 5, illustrating a further modification of the above embodiment. As shown in the figure, the FPC 70x may be folded back twice between the casing lid 33 and the movable lens frame 40, that is, three times in total, and also the number of folded back may be any larger number.

(3) The optical equipment of the embodiment is a camera system, but the optical equipments are not limited thereto, and may be binoculars, a telescope, a microscope, etc. Moreover, the vibration reduction apparatus according to the present invention may have been prepared for in electronic equipment including optical equipments such as portable telephones including a picture imaging function.

(4) The vibration reduction apparatus of the present embodiment moves the blur correcting lens on a plane perpendicular to the optical axis, but the present invention is not limited thereto, and the vibration reduction apparatus may be so constituted to move, for example, the imaging element such as a CCD or the like in the plane perpendicular to the optical axis, thereby correcting the image blur.

(5) The notch portion of the embodiment is formed so that the second notch and the third notch are orthogonal to the first notch, but it is not limited to thereto, as long as the notch is formed at the outer side of the Hall element and, for example, the boundary of these notches may be made in a curved shape. Moreover, these notches may not be a straight shape.

(6) In the vibration reduction apparatus of the embodiment, the Hall element is mounted on the mount portion, but the electronic part of the Hall element or the like, which control the relative movement of such a first member and second member may be mounted to, for example, other parts of the wiring board. In this case, the packaging area of electronic parts increases.

What is claimed is:

1. A vibration reduction apparatus comprising:
a first member and a second member disposed to be opposite to each other and to be movable relative to each other when blur is correcting; and
a wiring member that exerts a force between the first member and the second member along a direction that intersects with a direction of the relative movement of the first member and the second member.

2. The vibration reduction apparatus according to claim 1, wherein the wiring member exerts the force along a direction orthogonal to a plane on which the first member and the second member move relatively.

3. The vibration reduction apparatus according to claim 1, wherein the wiring member is provided to be bent between the first member and the second member.

4. The vibration reduction apparatus according to claim 1, wherein the wiring member has a first plane provided along the first member and a second plane provided along the second member.

5. The vibration reduction apparatus according to claim 4, wherein the first plane and the second plane of the wiring member are parallel with each other.

6. The vibration reduction apparatus according to claim 4, wherein the wiring member has a fixing portion secured to at least one of the first member and the second member, on at least one of the first plane and the second plane.

7. The vibration reduction apparatus according to claim 4, wherein the first plane includes:
a first fixing portion secured to the first member; and
a first movable portion provided from the first fixing portion along the first member to be movable relative to the first member.

8. The vibration reduction apparatus according to claim 7, wherein the second plane includes:
a second fixing portion secured to the second member; and
a second movable portion provided from the second fixing portion along the second member to be movable relative to the second member.

9. The vibration reduction apparatus according to claim 1, wherein the wiring member includes:
at least one bending portion provided by bending a portion which extends from a portion along at least one of the first member and the second member.

10. The vibration reduction apparatus according to claim 9, wherein even number of the bending portions are provided.

11. The vibration reduction apparatus according to claim 9, wherein a plurality of bending portions are provided on the wiring member, and the wiring member further comprising an opposite portion opposed to at least one of the first member and the second member between a bending portion and another bending portion.

12. The vibration reduction apparatus according to claim 1, wherein the wiring member includes:
a first wiring portion provided along a plane on which the first member and the second member moves relatively; and
a second wiring portion provided along a plane on which the first member and the second member moves relatively and apart from the first wiring portion.

13. The vibration reduction apparatus according to claim 12, wherein the second wiring portion is provided along a direction intersected with the direction that the first wiring portion is provided.

14. The vibration reduction apparatus according to claim 12, wherein the second wiring portion is provided along a direction orthogonal to the direction that the first wiring portion is provided.

15. The vibration reduction apparatus according to claim 12, wherein the wiring member comprises a connecting portion that connects the first wiring portion and the second wiring portion, the connecting portion being provided along least one of the first member and the second member.

16. The vibration reduction apparatus according to claim 12, wherein at least one of the first wiring portion and the second wiring portion comprises:
a first plane opposed to the first member;
a second plane opposed to the second member; and
at least one bending portion provided by bending a plane continuous with the first plane and the second plane.

17. The vibration reduction apparatus according to claim 16, wherein at least one part of the wiring member is a stripe shape.

18. The vibration reduction apparatus according to claim 1, wherein the wiring member is a flexible printed circuit.

19. The vibration reduction apparatus according to claim 1, further comprising a blur correcting lens provided on at least one of the first member and the second member.

20. The vibration reduction apparatus according to claim 1, further comprising an imaging element provided on at least one of the first member and the second member.

21. A vibration reduction apparatus comprising:
a first member and a second member provided to be opposite to each other and to be movable relative to each other when blur is correcting; and
a wiring member provided between the first member and the second member to connect the first member and the second member electrically,
wherein the wiring member exerts an elastic force between the first member and the second member along a direction that intersects with the direction of the relative movement of the first member and the second member.

22. The vibration reduction apparatus according to claim 21, wherein the wiring member comprises:
a first plane opposed to the first member;
a second plane opposed to the second member; and
at least one bending portion provided by bending a plane continuous with the first plane and the second plan.

23. A vibration reduction apparatus comprising:
a first member and a second member provided to be opposite each other and to be movable relative to each other when blur is correcting; and
a wiring member provided between the first member and the second member,
wherein the wiring member includes: a first plane opposed to the first member; a second plane opposed to the second member; and at least one bending portion provided by bending a plane continuous with the first plane and the second plane.

24. The vibration reduction apparatus according to claim 23, wherein the wiring member exerts a force between the first member and the second member along a direction that intersects with the direction of the relative movement of the first member and the second member.

25. The vibration reduction apparatus according to claim 23, wherein at least one of the first plane and the second plane has a fixing portion secured to at least one of the first member and the second member.

26. The vibration reduction apparatus according to claim 23, wherein the first plane includes:
a first fixing portion secured to the first member; and
a first movable portion provided from the first fixing portion along the first member to be movable relative to the first member.

27. The vibration reduction apparatus according to claim 26, wherein the second plane includes:
a second fixing portion secured to the second member; and
a second movable portion provided from the second fixing portion along the second member to be movable relative to the second member.

28. A vibration reduction apparatus comprising:
a sensor to detect relative movement of a first member and a second member movable relative to each other in a plane perpendicular to an optical axis when blur is correcting;
a loading portion to load the sensor and disposed on a plane perpendicular to the optical axis of the first member; and
a flexible member having a bending portion bent from the loading portion,
wherein the loading portion is provided with a notch portion at an outer side of the sensor.

29. The vibration reduction apparatus according to claim 28, wherein the loading portion is provided with notch portions on three portions at the outer side of the sensor.

30. The vibration reduction apparatus according to claim 28, wherein the flexible member is a flexible printed circuit.

31. The vibration reduction apparatus according to claim 28, wherein the notch portion has a first notch provided between the sensor and the bending portion of the flexible member.

32. The vibration reduction apparatus according to claim 31, wherein the notch portion has a second notch and a third notch respectively formed at each ends of the first notch continuously so as to dispose the sensor therebetween.

33. The vibration reduction apparatus according to claim 28, wherein the first member or the second member supports a blur correcting lens or an imaging element.

34. An optical equipment comprising a vibration reduction apparatus according to claim 1.

35. A method for manufacturing a vibration reduction apparatus, comprising steps of:
providing a first member and a second member opposite to each other and movable relative to each other when blur correcting; and
disposing wiring members to exert a force along a direction that intersects with a direction of relative movement of the first member and the second member between the first member and the second member.

36. A method of manufacturing a vibration reduction apparatus, comprising steps of:
providing a first member and a second member to be opposite to each other and to be movable relative to each other when blur correcting;
connecting electrically the first member and the second member via a wiring member, and
disposing the wiring member to exert an elastic force along a direction that intersects a direction of the relative movement of the first member and the second member between the first member and the second member.

37. A method of manufacturing a vibration reduction apparatus, comprising steps of:
providing a first member and a second member to be opposite to each other and to be movable relative to each other when blur correcting;
and disposing a wiring member between the first member and the second member so that a first plane is opposed to the first member and a second plane other than the first plane is opposed to the second member.
